(19) United States
(12) Patent Application Publication
(10) Pub. No.: US 2025/0108770 A1
(43) Pub. Date: Apr. 3, 2025

(54) CABLE FASTENER SYSTEM

(71) Applicant: Rivian IP Holdings, LLC, Irvine, CA (US)

(72) Inventors: Mae HUBEL, Irvine, CA (US); Tyler TISDALE, Lake Forest, CA (US); Edwin Raul OSORIO ZARAGOZA, Tustin, CA (US)

(21) Appl. No.: 18/895,605

(22) Filed: Sep. 25, 2024

Related U.S. Application Data
(60) Provisional application No. 63/586,980, filed on Sep. 29, 2023.

(51) Int. Cl. B60R 16/02; B60R 16/033

(52) U.S. Cl. CPC B60R 16/0215; B60R 16/033

(57) ABSTRACT

A cable fastening system is provided. The cable fastening system includes articulated and non-articulated cable fasteners. The articulated cable fastener includes a lower support, a lower body attached to the lower support, and an upper body connected to the lower body via a hinge and a connector. The lower body defines a first curved recess, a second curved recess, and a third curved recess. The upper body defines a first curved recess, a second curved recess, a third curved recess, and a cable recess disposed between the first recess and the second recess. The cable recess is configured to receive a cable. The non-articulated cable fastener includes a base and a cable support tray. The cable support tray includes a body, a first upper support extending from the body, and a second upper support extending from the body. The body defines an inner curved recess configured to accept the cable.

### CROSS-REFERENCE TO RELATED APPLICATIONS

This application claims priority to and benefit of U.S. Provisional Patent Application No. 63/586,980, filed Sep. 29, 2023, the entire contents of which are incorporated by reference herein in its entirety.

### INTRODUCTION

The present disclosure relates to a cable fastener system and cable fasteners.

An electric vehicle may have one or more electrical cables, such as one or more high voltage (HV) cables, that need to be routed from one end of the electric vehicle (such as the front), over or under the centrally-located battery pack, to the other end of the electric vehicle (such as the rear). In many cases, the upper and lower surfaces of the battery pack cannot accommodate traditional fastening points for the HV cable, such as weld studs, holes, etc.

### SUMMARY

Embodiments of the present disclosure advantageously provide a cable fastening system that includes articulated cable fasteners and non-articulated cable fasteners.

In certain embodiments, an articulated cable fastener includes a lower support, a lower body attached to the lower support, and an upper body connected to the lower body via a hinge and a connector. The lower body defines a first curved recess, a second curved recess and a third curved recess. The upper body defines a first curved recess, a second curved recess, a third curved recess, and a cable recess disposed between the first recess and the second recess. The cable recess is configured to receive a cable.

In certain embodiments, a non-articulated cable fastener includes a base and a cable support tray. The cable support tray includes a body, a first upper support extending from the body, and a second upper support extending from the body. The body defines an inner curved recess configured to accept a cable. The first upper support includes a flat surface disposed parallel to the body. The second upper support includes a flat surface disposed parallel to the body.

### BRIEF DESCRIPTION OF THE DRAWINGS

FIG. 1 depicts a diagram of an example electric vehicle, in accordance with embodiments of the present disclosure.

FIGS. 2A and 2B illustrate an example cable fastener system, in accordance with embodiments of the present disclosure.

FIGS. 3A to 3F illustrate several views of an example articulated cable fastener, in accordance with embodiments of the present disclosure.

FIGS. 4A to 4E illustrate several views of an example non-articulated cable fastener, in accordance with embodiments of the present disclosure.

### DETAILED DESCRIPTION

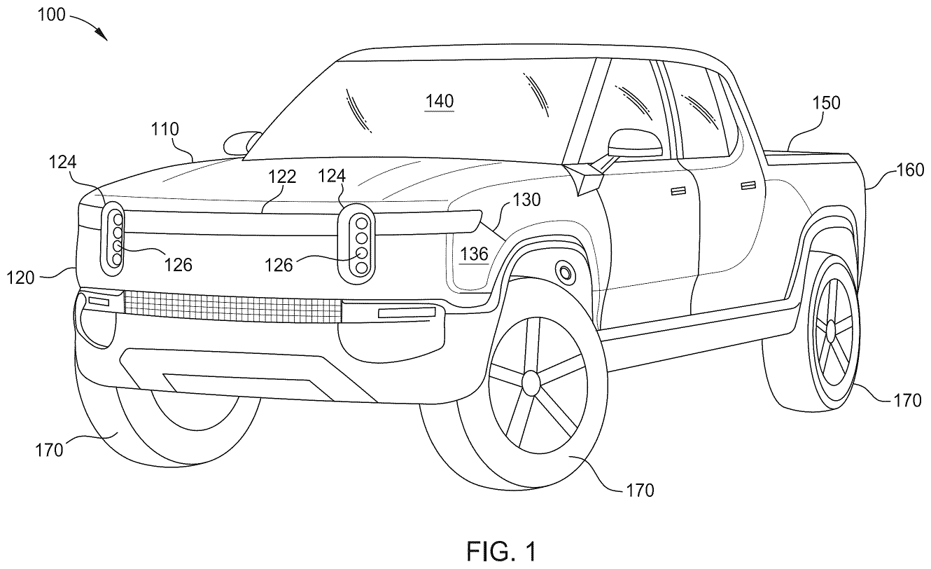

FIG. 1 depicts a diagram of electric vehicle 100, in accordance with embodiments of the present disclosure.

Electric vehicle 100 includes, inter alia, a frame and body 110, a propulsion system, a suspension system, a steering system, auxiliary and accessory systems (such as thermal management, electrical power distribution, lighting, wireless communications, navigation, etc.), etc.

Generally, body 110 may be directly or indirectly mounted to a frame (i.e., body-on-frame construction), or body 110 may be formed integrally with a frame (i.e., unibody construction). Body 110 includes, inter alia, front end 120, front light bar 122, stadium light ring 124, headlights 126, charging port 130 with charging port cover 136, driver/passenger compartment or cabin 140, bed 150, rear end 160 with a rear light bar, etc. Electric vehicle 100 may be a pickup truck, a sport utility vehicle (SUV) in which bed 150 is replaced by an extension of cabin 140, or a sedan in which bed 150 is replaced by a trunk. In certain embodiments, electric vehicle may be an electric delivery vehicle, an electric cargo van, etc.

The propulsion system may include, inter alia, one or more electronic control units (ECUs), one, two or four (or more) electric motors with associated drivetrains, wheels 170, an energy storage subsystem, etc. The energy storage subsystem may include, inter alia, one or more ECUs, a battery pack including one or more battery modules, a vehicle charging subsystem including charging port 130, etc.

In one example, an HV cable needs to be routed from an HV cable harness connected to the front of the battery pack, over the upper surface of the battery pack, to a positive temperature coefficient (PTC) heater for a thermal management system (TMS) located in the rear of the electric vehicle. In many cases, the upper and lower surfaces of the battery pack cannot accommodate traditional fastening points for the HV cable, such as weld studs, holes, etc.

Embodiments of the present disclosure advantageously provide a cable fastener system that takes advantage of existing TMS hoses that are routed over the upper surface of the battery pack in order to support one or more HV cables without the need to create additional fastening points on the battery pack or the body frame. Other hoses that are routed over or under the battery pack may also be used to support the HV cable using the cable fastener system, such as pneumatic hoses, hydraulic hoses, etc.

In certain embodiments, the cable fastener system includes articulated cable fasteners and non-articulated cable fasteners. For example, an articulated cable fastener has at least two components that are interconnected (coupled, linked, connected, jointed, etc.) and movable relative to one another. Conversely, a non-articulated cable fastener may have multiple components that are not movable relative to one another.

Other types of cable fastener devices may also be used in combination with the articulated and non-articulated cable fasteners. Generally the routing of the support hoses determines the number and location of each type of cable fastener device. In certain other embodiments, the cable fastener system may include only articulated cable fasteners, or the cable fastener system may include only non-articulated cable fasteners.

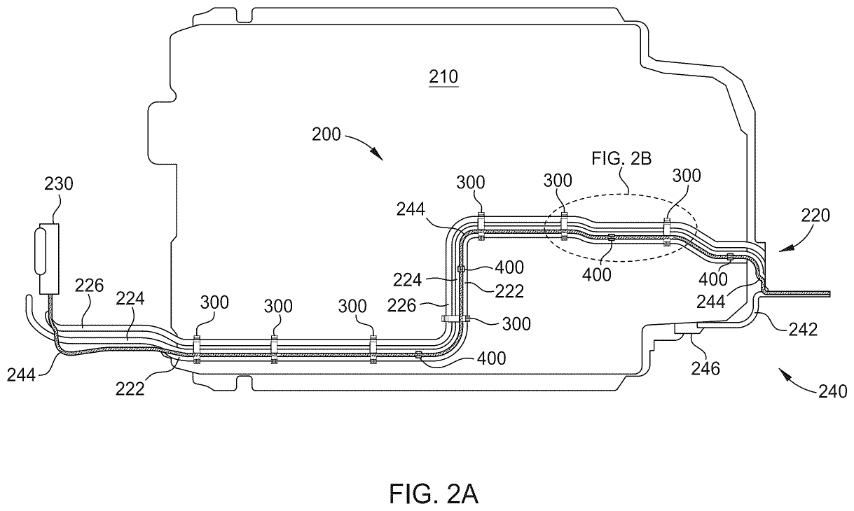

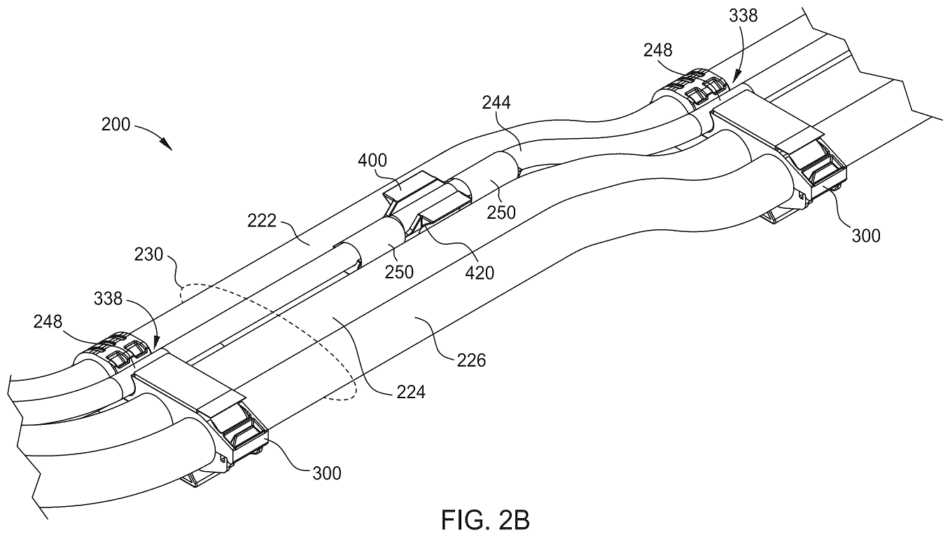

FIGS. 2A and 2B illustrate cable fastener system 200, in accordance with embodiments of the present disclosure.

FIG. 2A depicts cable fastener system 200, battery pack 210, a portion of TMS system 220, PTC heater 230, and a portion of HV cable system 240, in accordance with embodiments of the present disclosure. A top view of battery pack 210 is provided, illustrating the routing of TMS system 220, HV branch cable 244, and cable fastener system 200 along the upper surface of battery pack 210.

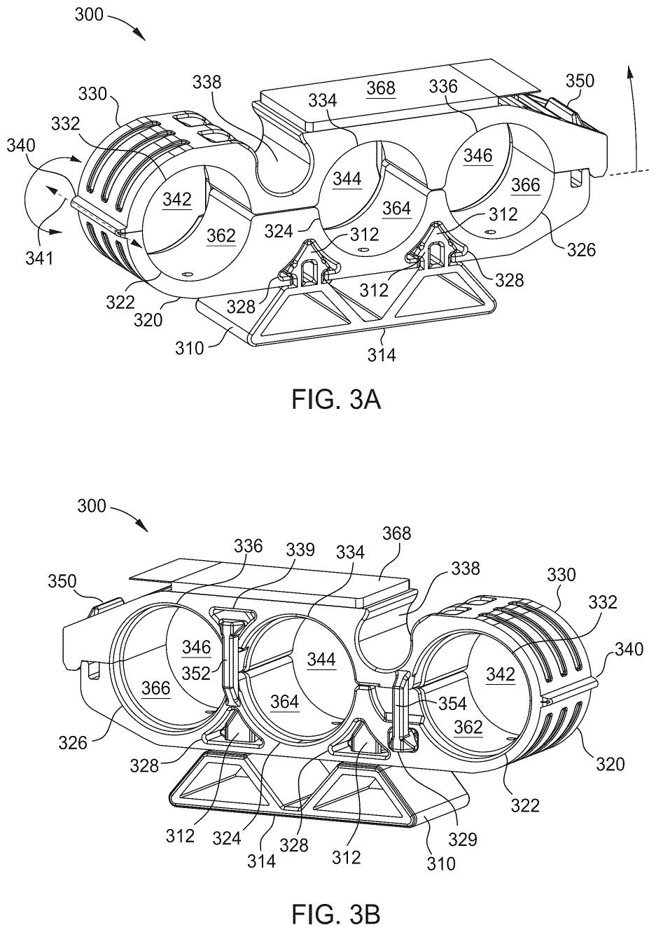

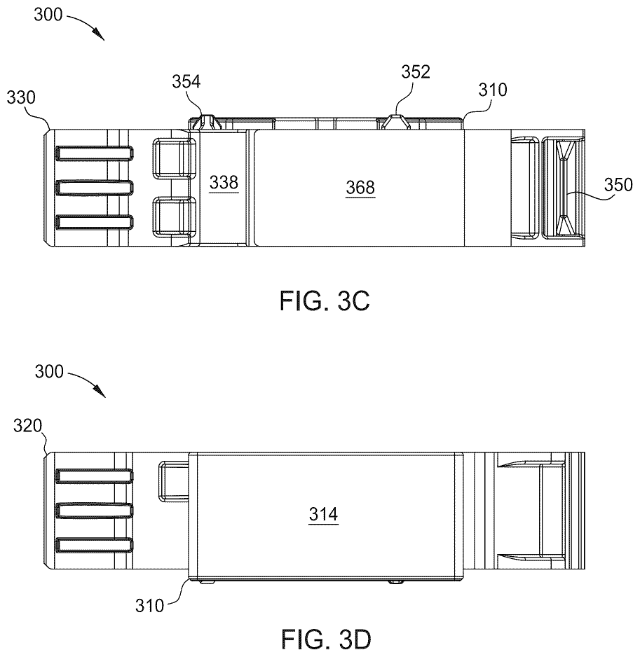

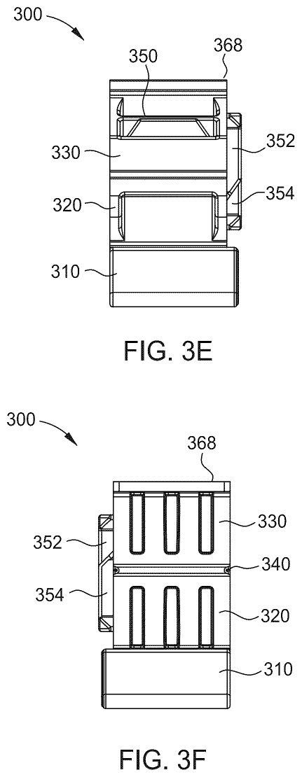

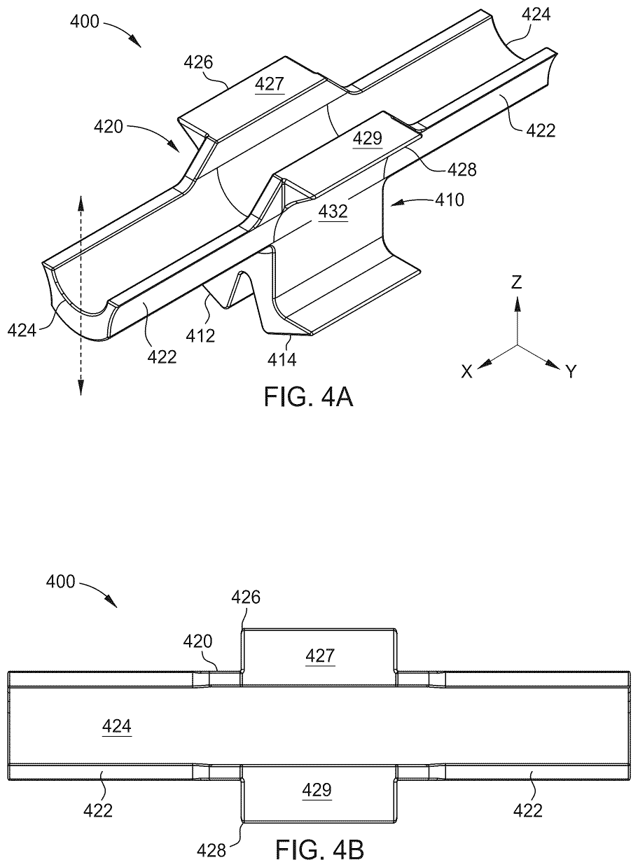

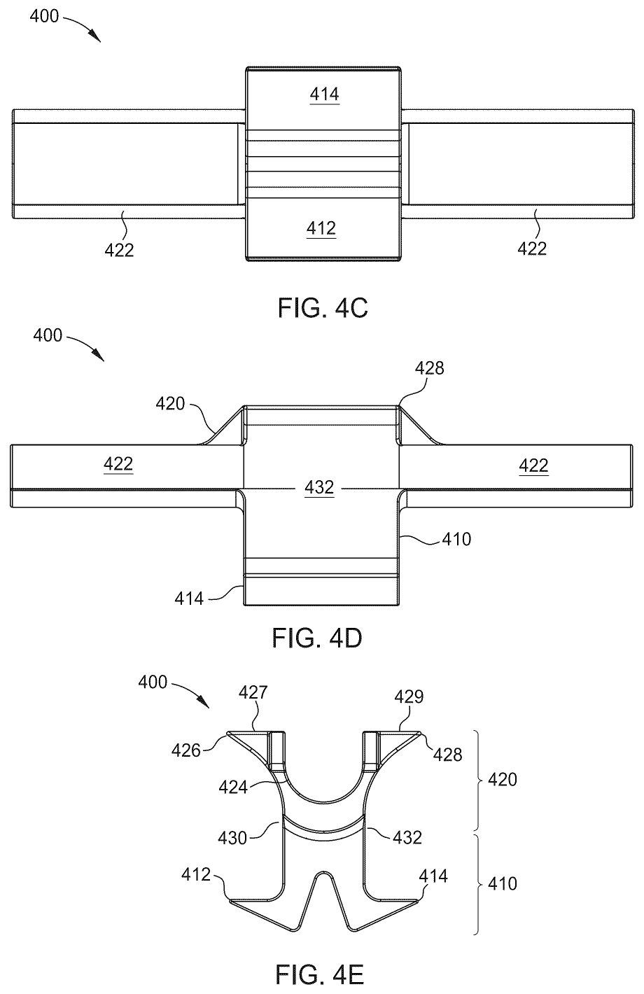

In this example, cable fastener system 200 includes seven (7) articulated cable fasteners 300 and four (4) non-articulated cable fasteners 400. Different numbers of articulated cable fasteners 300 and non-articulated cable fasteners 400, as well as different installation locations, are also supported. Articulated cable fastener 300 is discussed in more detail with respect to FIGS. 3A to 3F, and non-articulated cable fastener 400 is discussed in more detail with respect to FIGS. 4A to 4E.

TMS system 220 includes, inter alia, hoses 222, 224, 226 that are routed from the front of battery pack 210, over the upper surface of battery pack 210, to the rear of battery pack 210. Hoses 224, 226 are then routed to PTC heater 230. Generally, hoses 222, 224, 226 may be secured to the upper surface of battery pack 210 using traditional fittings, clamps, etc. Different numbers of hoses, such as 2 hoses, 4 hoses, etc., as well as different routing paths, are also supported.

HV cable system 240 includes, inter alia, HV main cable 242, HV branch cable 244, and HV connector 246. HV connector 246 is located near the front end of battery pack 210, and connects HV main cable 242 to battery pack 210. HV branch cable 244 branches off HV main cable 242 at the front end of battery pack 210, and is routed with hoses 222, 224, 226 from the front of battery pack 210, over the upper surface of battery pack 210, to the rear of battery pack 210. HV branch cable 244 is then routed from the rear of battery pack 210 to PTC heater 230, and generally follows the path of hoses 222, 224. In certain embodiments, HV branch cable 244 may be secured to hose 224 or hose 226 (between the rear of battery pack 210 and PTC heater 230) using one or more cable clips, adhesive tape strips, hook-and-loop fasteners, etc.

FIG. 2B depicts a portion of cable fastener system 200 (identified in FIG. 2A), in accordance with embodiments of the present disclosure.

In the example depicted in FIG. 2B, cable fastener system 200 supports and routes HV branch cable 244 between hose 222 and hose 224 of TMS system 220. Two (2) articulated cable fasteners 300 and one (1) non-articulated cable fasteners 400 are depicted in FIG. 2B. Each articulated cable fastener 300 is attached to hoses 222, 224, 226 (as described below), while the non-articulated cable fastener 400 has been installed between hose 222 and hose 224, about mid-way between the articulated cable fasteners 300. The non-articulated cable fastener 400 remains in place due to the arcuate shape of its outer surfaces and the transverse stiffness of hoses 222, 224.

In certain embodiments, cable sleeves 248 encircle a small portion of HV branch cable 244 adjacent to each articulated cable fastener 300. Each cable sleeve 248 may be flexible and have a longitudinal slot, gap, etc., that permits the installation onto HV branch cable 244 at the proper location by deforming cable sleeve 248 and inserting HV branch cable 244 through the slot. Alternatively, each cable sleeve 248 may be installed onto HV branch cable 244 by sliding a less-flexible cable sleeve 248 along HV branch cable 244 from one end to the proper location.

Each cable sleeve 248 is configured to engage cable recess 338 of a respective articulated cable fastener 300 to secure HV branch cable 244 to the respective articulated cable fastener 300. In certain embodiments, cable sleeve 248 may have an inner diameter that is the same as, or slightly larger than, HV branch cable 244, and an outer diameter that is slightly larger than the inner diameter of cable recess 338 to provide a secure connection, such as a snap fit, a press fit, a friction fit, etc., to the respective articulated cable fastener 300. In other certain embodiments, cable sleeve 248 may be secured within cable recess 338 using non-permanent or permanent methods, such as adhesive tape, glue, epoxy, etc.

In certain other embodiments, cable sleeves 248 are not needed, and the outer diameter of HV branch cable 244 may be slightly larger than the inner diameter of cable recess 338 to provide a secure connection, such as a snap fit, a press fit, a friction fit, etc., to the respective articulated cable fastener 300. Alternatively, HV branch cable 244 may be secured within cable recess 338 using non-permanent or permanent methods, such as adhesive tape, glue, epoxy, etc.

In certain embodiments, non-articulated cable fastener 400 may include cable support tray 420 that is configured to support a portion of HV branch cable 244. Prior to installation, HV branch cable 244 may be secured within an inner, curved recess of the cable support tray using non-permanent or permanent methods, such as adhesive tape 250, hook-and-loop fasteners, glue, epoxy, etc. In the example depicted in FIG. 2B, adhesive tape 250 may be wrapped around the cable support tray, and a respective portion of HV branch cable 244, at each end of non-articulated cable fastener 400.

FIGS. 3A to 3F illustrate several views of articulated cable fastener 300, in accordance with embodiments of the present disclosure.

FIGS. 3A and 3B depict front and rear perspective views, respectively, of articulated cable fastener 300, in accordance with embodiments of the present disclosure. In certain embodiments, articulated cable fastener 300 includes, inter alia, lower support 310, lower body 320, upper body 330, hinge 340, and lock 350.

Lower support 310 includes, inter alia, two projections 312 and lower surface 314.

In the example depicted in FIG. 3A et seq., two projections 312 are depicted; in other examples, a single projection 312 may be used, three or more projections 312 may be used, etc. In certain embodiments, lower support 310 may be integrally formed with lower body 320, and no projections 312 are needed. When installed, lower surface 314 rests on the upper surface of battery pack 210.

Lower body 320 defines three curved recesses 322, 324, 326, and two projection passageways 328.

Each curved recess 322, 324, 326 has a cylindrical shape, and is configured to receive a lower portion of one of the hoses. In the example depicted in FIG. 3A et seq., three curved recesses 322, 324, 326 are depicted. When installed, curved recess 322 receives and supports a corresponding portion of the lower half of hose 222, curved recess 324 receives and supports a corresponding portion of the lower half of hose 224, and curved recess 326 receives and supports a corresponding portion of the lower half of hose 226. In other examples, two curved recesses may be used, four curved recesses may be used, etc.

Each projection passageway 328 receives a respective projection 312 to secure lower support 310 to lower body 320. Projections 312 may be pressed through openings in the lower surface of lower body 320 to enter projection passageways 328 from below. Alternatively, projections 312 may be pressed through openings in the front surface of lower body 320 to enter projection passageways 328 from the front. As discussed above, two projection passageways 328 are depicted in FIG. 3A et seq.; in other examples, a single connection passageway may be used, three or more connection passageways may be used, etc. In certain embodiments, lower support 310 may be integrally formed with lower body 320, and no projection passageways 328 are needed.

Upper body 330 defines curved recesses 332, 334, 336, and cable recess 338.

Each curved recess 332, 334, 336 has a cylindrical shape, and is configured to receive a corresponding upper portion of one of the TMS hoses. In the example depicted in FIG. 3A et seq., three curved recesses 332, 334, 336 are depicted. When installed, curved recess 332 receives and supports a corresponding portion of the upper half of hose 222, curved recess 334 receives and supports a corresponding portion of the upper half of hose 224, and curved recess 336 receives and supports a corresponding portion of the upper half of hose 226. In other examples, two curved recesses may be used, four curved recesses may be used, etc. Cable recess 338 also has a cylindrical shape, and is configured to receive and support cable sleeve 248 (or, alternatively, HV branch cable 244).

Hinge 340 couples lower body 320 to upper body 330, and has rotation axis 341.

In certain embodiments, hinge 340 may be a living hinge that is integrally formed with lower body 320 and upper body 330. In other certain embodiments, hinge 340 may be a butt hinge, a barrel hinge, a piano hinge, etc., and a portion of hinge 340 may be formed in lower body 320 and a complementary portion may be formed in upper body 330. Upper body 330 rotates about rotation axis 341 from an open state prior to installation (not depicted) to a closed state after installation (depicted in FIG. 2B, FIG. 3A set seq.). In the closed state, curved recess 322 and curved recess 332 form passageway 342 for hose 222, curved recess 324 and curved recess 334 form passageway 344 for hose 224, and curved recess 326 and curved recess 336 form passageway 346 for hose 226. In certain embodiments, passageways 342, 344, 346 may be circular. In other examples, two passageways may be formed, four passageways may be formed, etc.

Lock 350 secures upper body 330 to lower body 320 when upper body 330 is disposed in the closed state. In the example depicted in FIG. 3A et seq., lock 350 may be a snap-fit connector that has a portion formed in lower body 320 (such as a cantilever arm with a locking hook disposed on the tip) and a portion formed in upper body 330 (such as a passageway with a locking segment, wall, etc., configured to receive the locking hook of the cantilever arm tip). Other types of locking mechanisms may also be used.

Generally, lock 350 may provide a permanent connection between upper body 330 and lower body 320, or a non-permanent connection between upper body 330 and lower body 320. A permanent connection secures upper body 330 to the lower body 320, and does not allow upper body 330 to transition from the closed state to the open state. Conversely, a non-permanent connection releasably secures the upper body 330 to the lower body 320, and allows the upper body 330 to transition from the closed state to the open state.

To install articulated cable fastener 300, the upper body 330 is arranged in the open state, and the lower body 320 is placed under hoses 222, 224, 226 such that the lower portion of each hose 222, 224, 226 rests within a respective curved recess 322, 324, 326 of lower body 320. Upper body 330 is then rotated from the open state to the closed state, such that the upper portion of each hose 222, 224, 226 rests within a respective curved recess 332, 334, 336 of upper body 330, and hoses 222, 224, 226 are disposed within respective passageways 342, 344, 346. In the closed state, lock 350 secures upper body 330 to lower body 320. Cable sleeve 248 is then snapped into cable recess 338 to secure HV branch cable 244 to articulated cable fastener 300.

In certain embodiments, liners 362, 364, 366 may be inserted into passageways 342, 344, 346 formed by curved recesses 322 and 332, 324 and 334, 326 and 336, respectively, to protect hoses 222, 224, 226 from chafing, rubbing, abrading, etc. Liners 362, 364, 366 may be formed in two segments, and inserted into curved recesses 322 and 332, 324 and 334, 326 and 336, respectively, prior to installation. Double-sided adhesive tape 368 may be affixed to the upper surface of upper body 330.

In certain embodiments, articulated cable fastener 300 may include locks 352, 354 to provide additional strength, rigidity, etc., when upper body 330 is disposed in the closed state. In the example depicted in FIG. 3B et seq., lock 352 may be a snap-fit connector that has a portion formed in lower body 320 (such as a cantilever arm with a locking hook disposed on the tip) and a portion formed in upper body 330 (such as recess 339 with a locking segment, etc., configured to receive the locking hook of the cantilever arm tip). Similarly, lock 354 may be a snap-fit connector that has a portion formed in upper body 330 (such as a cantilever arm with a locking hook disposed on the tip) and a portion formed in lower body 320 (such as recess 329 with a locking segment, etc., configured to receive the locking hook of the cantilever arm tip). As discussed above with respect to lock 350, locks 352, 354 may provide a permanent connection between upper body 330 and lower body 320, or a non-permanent connection between upper body 330 and lower body 320. Other types of locking mechanisms may also be used.

FIGS. 3C and 3D depict top and bottom views, respectively, of articulated cable fastener 300, in accordance with embodiments of the present disclosure. Lower support 310, upper body 330, cable recess 338, locks 352, 354 and adhesive tape 368 are visible in FIG. 3C, while lower support 310, lower surface 314, and lower body 320 are visible in FIG. 3D.

FIGS. 3E and 3F depict left and right views, respectively, of articulated cable fastener 300, in accordance with embodiments of the present disclosure. Lower support 310, lower body 320, upper body 330, locks 352, 354, and adhesive tape 368 are visible.

FIGS. 4A to 4E illustrate several views of non-articulated cable fastener 400, in accordance with embodiments of the present disclosure.

FIG. 4A depicts a left side perspective view of non-articulated cable fastener 400, in accordance with embodiments of the present disclosure. Generally, non-articulated cable fastener 400 may be symmetric about a centerline X-Z plane.

In certain embodiments, non-articulated cable fastener 400 includes, inter alia, base 410 and cable support tray 420.

Base 410 may include lower support 412 and lower support 414.

Cable support tray 420 may include body 422, upper support 426, and upper support 428. Body 422 defines curved recess 424 that is configured to accept HV branch cable 244. Upper support 426 extends from body 422, and includes flat upper surface 427 that is disposed parallel to body 422. Upper support 428 extends from body 422, and includes flat upper surface 429 that is disposed parallel to body 422.

As depicted in FIGS. 4A and 4E, the outer surface of base 410 (including a portion of lower support 414) and the outer surface of cable support tray 420 (include a portion of upper support 428) define arcuate surface 432 that is configured to contact hose 222 (or hose 224). Similarly, as depicted in FIG. 4E, the outer surface of base 410 (including a portion of lower support 414) and the outer surface of cable support tray 420 (include a portion of upper support 428) define arcuate surface 432 that is configured to contact hose 224 (or hose 222).

In certain embodiments, a portion of lower support 412 may be formed from a flexible material, and a portion of lower support 414 may be formed from a flexible material.

To install non-articulated cable fastener 400, HV branch cable 244 is first secured to each end of cable support tray 420 using adhesive tape, wire ties, etc. (as depicted in FIG. 2B), and then non-articulated cable fastener 400 is pressed between hoses 222, 224 and retained in place by contact between hoses 222, 224 and non-articulated cable fastener 400. Flat upper surfaces 427, 429 may be used to press non-articulated cable fastener 400 between hoses 222, 224.

FIGS. 4B and 4C depict top and bottom views, respectively, of non-articulated cable fastener 400, in accordance with embodiments of the present disclosure. Cable support tray 420, body 422, curved recess 424, upper support 426, flat upper surface 427, upper support 428, and flat upper surface 429 are visible in FIG. 4B, while body 422, lower support 412, and lower support 414 are visible in FIG. 4C.

FIG. 4D depicts a left side view of non-articulated cable fastener 400, in accordance with embodiments of the present disclosure. Base 410, lower support 414, cable support tray 420, upper support 428, and arcuate surface 432 are visible in FIG. 4D.

FIG. 4E depicts a front view of non-articulated cable fastener 400, in accordance with embodiments of the present disclosure. Base 410, lower support 412, lower support 414, cable support tray 420, curved recess 424 upper support 426, flat upper surface 427, upper support 428, flat upper surface 429, arcuate surface 430, and arcuate surface 432 are visible in FIG. 4D.

In certain other embodiments, non-articulate cable fastener 400 may be used to secure an electrical cable in any location of electric vehicle 100 that allows non-articulate cable fastener 400 to be wedged between, and retained by, two vehicle structures, such as two TMS hoses, two pneumatic hoses, two hydraulic hoses, two body components, two frame components, two vehicle trim components, etc.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. An articulated cable fastener device, comprising:
a lower support;
a lower body, attached to the lower support, the lower body defining a first curved recess, a second curved recess, and a third curved recess; and
an upper body, connected to the lower body via a hinge and a connector, the upper body defining a first curved recess, a second curved recess, a third curved recess, and a cable recess configured to accept a cable,
wherein the first curved recess of the lower body and the first curved recess of the upper body form a first circular passageway configured to accept a first hose, the second curved recess of the lower body and the second curved recess of the upper body form a second circular passageway configured to accept a second hose, and the third curved recess of the lower body and the third curved recess of the upper body form a third circular passageway.

2. The articulated cable fastener device of claim 1, wherein the hinge is a living hinge.

3. The articulated cable fastener device of claim 2, wherein:
the connector is a snap-fit connector;
a lower portion of the connector is formed in the lower body; and
an upper portion of the connector is formed in the upper body.

4. The articulated cable fastener device of claim 3, further comprising:
an additional connecter including a cantilever arm extending from the upper body, and a recess formed in the lower body,
wherein the recess is configured to secure an end portion of the cantilever arm.

5. The articulated cable fastener device of claim 3, further comprising:
an additional connecter including a cantilever arm extending from the lower body, and a cooperating recess formed in the upper body,
wherein the cooperating recess is configured to secure an end portion of the cantilever arm.

6. The articulated cable fastener device of claim 1, wherein the lower body defines at least one projection passageway, and the lower support includes at least one projection that cooperates with the projection passageway to attach the lower support to the lower body.

7. The articulated cable fastener device of claim 1, further comprising a liner for each circular passageway.

8. A non-articulated cable fastener device, comprising:
a base; and
a cable support tray, disposed on the base, the cable support tray including:
a body defining a curved recess configured to accept a cable,
a first upper support extending from the body, the first upper support including a flat surface disposed parallel to the body, and
a second upper support extending from the body, the second upper support including a flat surface disposed parallel to the body.

9. The non-articulated cable fastener device of claim 8, wherein the base includes:
a first lower support including a flexible portion; and
a second lower support including a flexible portion.

10. The non-articulated cable fastener device of claim 9, wherein:
a first outer surface of the base and a first outer surface of the cable support tray define a first arcuate surface configured to contact a first vehicle structure; and
a second outer surface of the base and a second outer surface of the cable support tray define a second arcuate surface configured to contact a second vehicle structure.

11. The non-articulated cable fastener device of claim 10, wherein the first vehicle structure is a first hose, and the second vehicle structure is a second hose.

12. A cable fastener system, comprising:
an articulated cable fastener, including
a lower support,
a lower body attached to the lower support, the lower body defining a first curved recess, a second curved recess, and a third curved recess, and
an upper body connected to the lower body via a hinge and a connector, the upper body defining a first curved recess, a second curved recess, a third curved recess, and a cable recess disposed between the first curved recess and the second curved recess, the cable recess configured to receive a cable; and
a non-articulated cable fastener, including:
a base, and
a cable support tray including:
a body defining a curved recess configured to accept the cable,
a first upper support extending from the body, the first upper support including a flat surface disposed parallel to the body, and
a second upper support extending from the body, the second upper support including a flat surface disposed parallel to the body.

13. The cable fastener system of claim 12, wherein:
the first curved recess of the lower body and the first curved recess of the upper body form a first circular passageway configured to receive a first hose;
the second curved recess of the lower body and the second curved recess of the upper body form a second circular passageway configured to receive a second hose; and
the third curved recess of the lower body and the third curved recess of the upper body form a third circular passageway configured to receive a third hose.

14. The cable fastener system of claim 13, wherein:
a first outer surface of the base and a first outer surface of the cable support tray define a first arcuate surface configured to contact the first hose; and
a second outer surface of the base and a second outer surface of the cable support tray define a second arcuate surface configured to contact the second hose.

15. The cable fastener system of claim 14, wherein the hinge is a living hinge.

16. The cable fastener system of claim 15, wherein:
the connector is a snap-fit connector;
a lower portion of the connector is formed in the lower body; and
an upper portion of the connector is formed in the upper body.

17. The cable fastener system of claim 16, further comprising:
an additional connecter including a cantilever arm extending from the upper body, and a cooperating recess formed in the lower body,
wherein the cooperating recess is configured to secure an end portion of the cantilever arm.

18. The cable fastener system of claim 16, further comprising:
an additional connecter including a cantilever arm extending from the lower body, and a cooperating recess formed in the upper body,
wherein the cooperating recess is configured to secure an end portion of the cantilever arm.

19. The cable fastener system of claim 12, wherein the lower body defines at least one projection passageway, and the lower support includes at least one projection that cooperates with the projection passageway to attach the lower support to the lower body.

20. The cable fastener system of claim 13, further comprising a liner for each circular passageway.
